(19) United States
(12) Patent Application Publication
(10) Pub. No.: US 2017/0258229 A1
(43) Pub. Date: Sep. 14, 2017

(54) DEVICES AND METHODS FOR LEVELING SHELVES IN A LABORATORY CLIMATIC CABINET

(71) Applicant: Thermo Fisher Scientific (Asheville) LLC, Asheville, NC (US)

(72) Inventor: Chris Siffel, Midland Park, NJ (US)

(21) Appl. No.: 15/457,568

(22) Filed: Mar. 13, 2017

Related U.S. Application Data
(60) Provisional application No. 62/307,951, filed on Mar. 14, 2016.

(51) Int. Cl. A47B 96/07; B01L 9/00; A47B 57/34

(52) U.S. Cl. CPC A47B 96/07; A47B 57/34; B01L 9/00

(57) ABSTRACT

A shelf support for leveling a shelf of a laboratory climatic cabinet is provided. The shelf support includes a shelf support body configured to be secured to a wall of the laboratory climatic cabinet and to support the shelf and at least one shelf leveling mechanism associated with the shelf support body. When the shelf is supported by the shelf support, the at least one shelf leveling mechanism is configured to adjust a distance between the shelf and a floor of the laboratory climatic cabinet. A laboratory climatic cabinet is provided and includes a shelf support, which includes a shelf support body configured to support the shelf and a shelf leveling mechanism, secured to a first wall of the cabinet. When a shelf is supported by the shelf support, the shelf leveling mechanism is configured to adjust a distance between the shelf and a floor of the cabinet.

### CROSS-REFERENCE TO RELATED APPLICATIONS

The present application claims the filing benefit of U.S. Provisional Application No. 62/307,951, filed Mar. 14, 2016, the disclosure of which is hereby incorporated herein by reference in its entirety.

### TECHNICAL FIELD

The present invention relates generally to a laboratory climatic cabinet, also referred to as an incubator, and, more particularly, to laboratory climatic cabinets having individually adjustable shelves mounted in the interior of the cabinet.

### BACKGROUND

Incubators are typically used in laboratories for the purpose of storing or growing samples, especially biological and/or microbiological samples, in their interior under predefined conditions, such as a specific temperature, to facilitate growth of eukaryotic or prokaryotic cells in various single cellular and multi-cellular forms. In certain incubators, the predefined conditions controlled also include ambient humidity and a defined gas atmosphere. The attempt is made in certain incubators to imitate the conditions of the human or animal body. In some applications for incubators, conditions are often selected to include a temperature of approximately 37° C. and can include temperatures ranging from 4° C. to 65° C. and the highest possible ambient humidity, which is typically to be at least 60% and preferably at least 90%, without moisture condensing out on the walls or other areas of the incubator.

A level surface is usually important for the distribution of the sample contents in the incubator. To that end, incubators often include adjustable feet for leveling the incubator. However, the degree of levelness required varies by application. For example, certain cell culture applications, such as skin cell growth, may involve a relatively low amount of cell growth media in each container within the incubator. Due to the low level of cell growth media in those applications, uniform distribution of the medium is imperative for desired cell growth. However, adjustable feet do not allow for the fine-tuning necessary to meet the strict leveling requirements imposed by such low medium cell culture applications. While the incubator as a whole may be level, the interior shelves mounted within the incubator may not be completely level due to machining tolerances and other factors. Moreover, incubators are often stacked one atop another. Stacking incubators increases the built-up tolerances of the dimensions and, thus, reduces the ability to provide a level shelf surface. Thus, there is an increasing need to provide improved incubators that address one or more of the above-identified drawbacks.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of a laboratory climatic cabinet including shelf supports according to an embodiment.

FIG. 2 is a perspective view of a shelf support according to an embodiment.

FIG. 3 is an enlarged view of the shelf leveling mechanisms of FIG. 2.

FIG. 4 is a perspective view of a shelf being supported by the shelf support of FIG. 2.

FIGS. 5-11 are perspective views of shelf supports according to various other embodiments.

### DETAILED DESCRIPTION

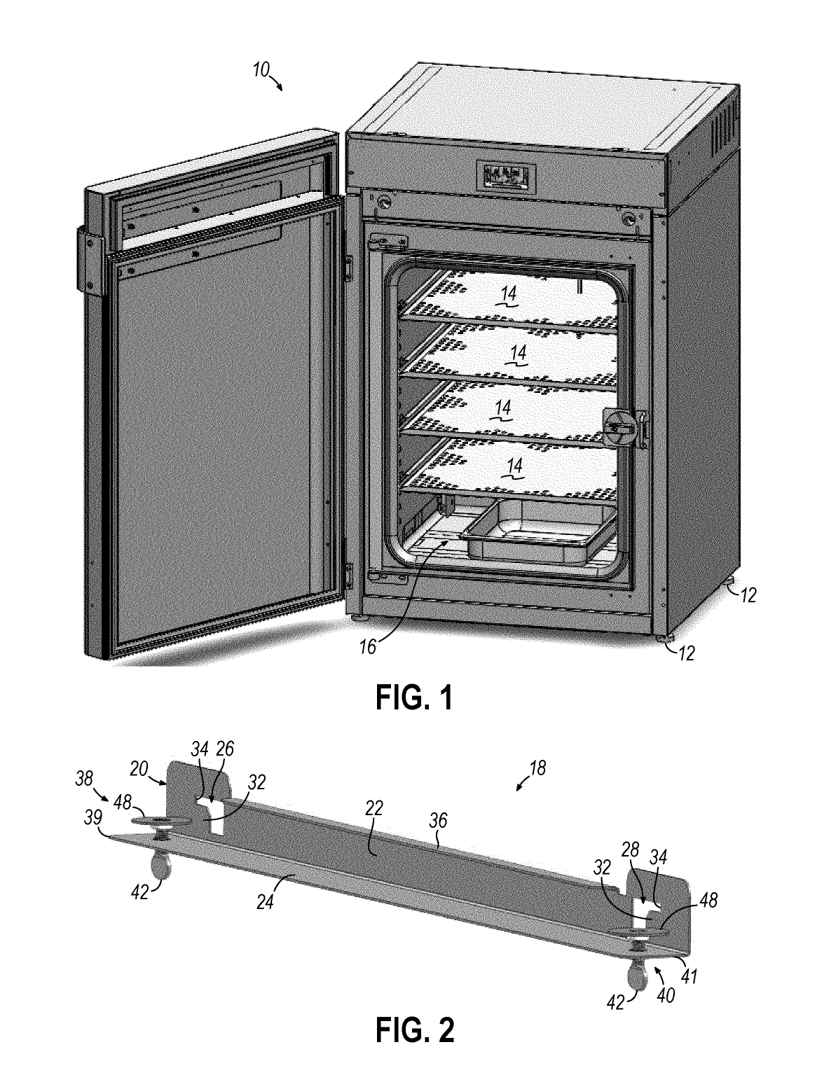

Referring generally to FIG. 1, a laboratory climatic cabinet, incubator 10, is shown constructed in accordance with an illustrative embodiment. The incubator 10 includes adjustable feet 12, which are used to adjust the leveling of the incubator 10. The incubator 10 includes a cabinet 16 containing a series of shelves 14 for holding samples (not shown). To provide a more accurate adjustment of the level of each of the shelves 14, the incubator 10 includes shelf supports having shelf leveling mechanisms, which are described in further detail below.

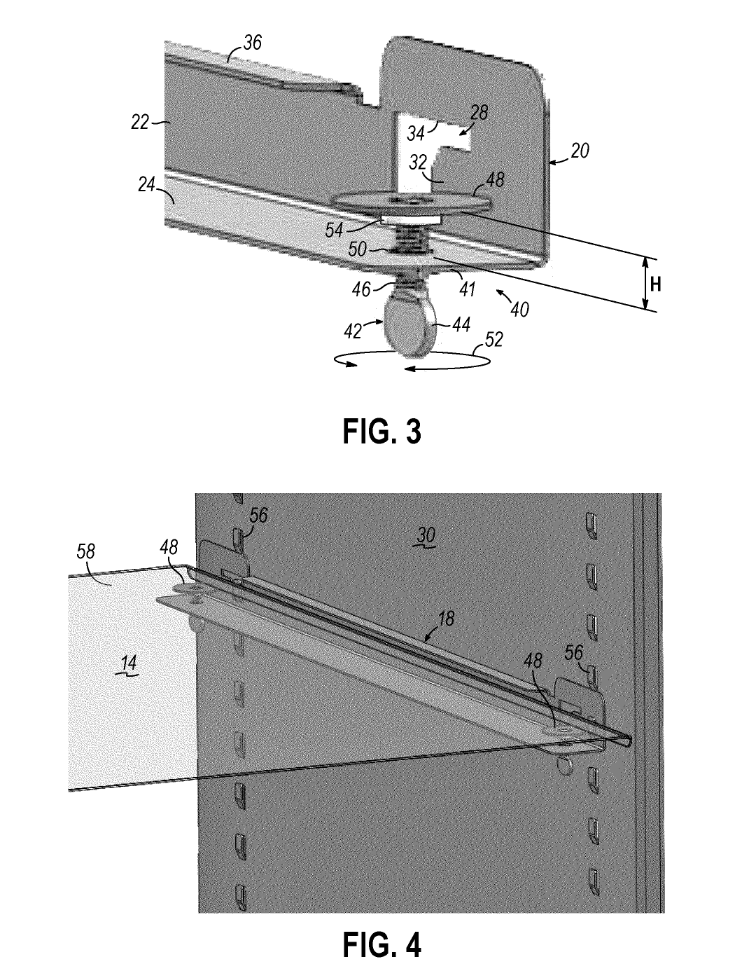

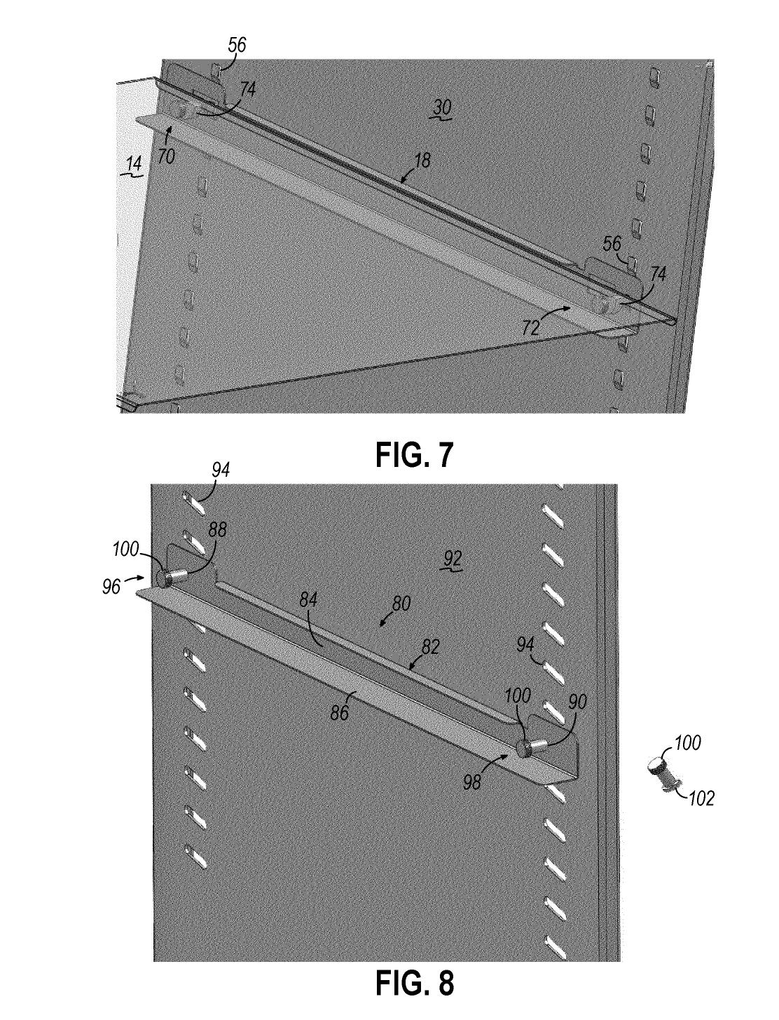

With reference to FIG. 2, a shelf support 18 is shown constructed in accordance with an illustrative embodiment. The shelf support 18 comprises a shelf support body, which is illustrated as an elongate body 20 including an upright wall 22 and a ledge 24. The upright wall 22 includes two apertures 26, 28 for securing the shelf support 18 to an incubator wall 30 (shown in FIG. 4). Each of the apertures 26, 28 includes a duct tab 32 and a shelf channel 34. The duct tabs 32 cooperate with features on the incubator wall 30 to secure the shelf support 18. The shelf channels 34 physically constrain the shelf support 18 in the forward and backward direction. The upright wall 22 also includes an overhang 36 for preventing the shelf 14 from falling out while being slid forward. The ledge 24 is configured to operatively support the shelf 14 when the shelf 14 is placed in the incubator 10 (shown in FIG. 4). Shelf leveling mechanisms 38, 40 are associated with the shelf support 18. In an embodiment, the shelf leveling mechanism 38 is located adjacent a first end 39 of the ledge 24, and the shelf leveling mechanism 40 is located adjacent a second end 41 of the ledge 24.

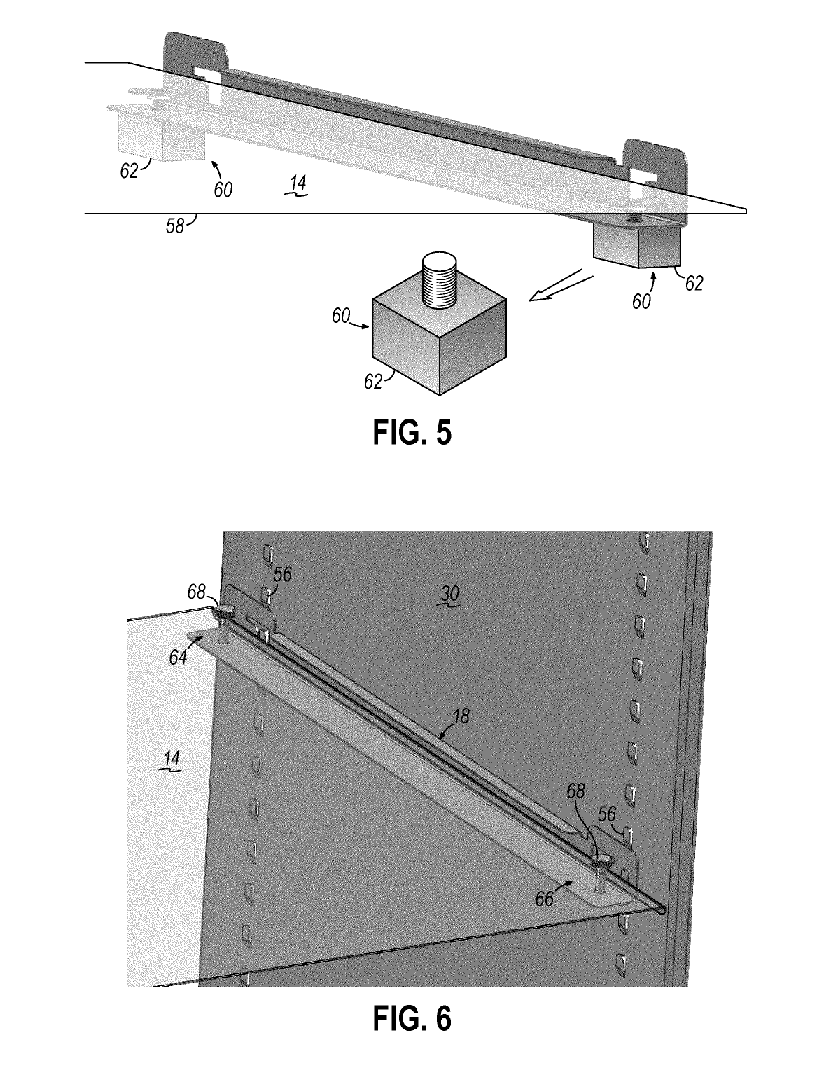

With further reference to FIG. 3, the shelf leveling mechanism 40 is shown in more detail. The description of the shelf leveling mechanism 40 applies equally to the shelf leveling mechanism 38. The shelf leveling mechanism 40 is configured to adjust the level of the shelf 14 independently of the level of the incubator 10. To that end, in an embodiment, the shelf leveling mechanism 40 includes a thumb screw 42 coupled to a support platform 48. The thumb screw 42 includes threads 46 and a grip 44. The thumb screw 42 extends through a bore 50 in the ledge 24, and threads 46 of the thumb screw 42 are engaged with the bore 50. The thumb screw 42 is rotatable within the bore 50 as indicated by arrow 52. Rotation of the thumb screw 42 adjusts the height H of the support platform 48 relative to the ledge 24. Put another way, rotation of the thumb screw 42 adjusts the distance between the support platform 48 and the floor of the incubator cabinet 16 (shown in FIG. 1). The thumb screw 42 also includes an insert 54 coupled to the thumb screw 42 and the support platform 48, which serves as the primary joint to mount the support platform 48 to the thumb screw 42. When the support platform 48 reaches its lowest position (not shown), the insert 54 abuts the ledge 24 and prevents further movement of the support platform 48 in a direction toward the ledge 24. When the support platform 48 reaches its highest position (not shown), the grip 44 abuts an underside of the ledge 24 and prevents further movement of the support platform 48 in a direction away from the ledge 24. Similar to other components used in the incubator 10, the shelf support 18, including the shelf leveling mechanisms 38, 40, is sterilizable (with the biological contents removed, but the shelves and other hardware components remaining assembled). For example, in some embodiments, the shelf support 18 may be removable from the incubator 10 and is autoclavable. Exemplary materials for the shelf support 18 include stainless steel, copper, or any other metallic or high temperature (e.g., greater than 90° C.) non-metallic components. The components of the shelf support 18 may be removable and able to be placed into an autoclave, after which the components may be reinstalled into the incubator 10. Alternatively, the components may be removable, yet left in the incubator 10 and sterilized while in place. Further, the components may be permanently fixed in the incubator 10 and sterilized while in place. In any of these scenarios, individual adjustment of the shelf 14 may be needed after the sterilization process is performed. Where shelf leveling mechanisms (e.g., mechanisms 38, 40) are installed in the four corners of the incubator 10, the shelf adjustment procedure would begin with the support platforms 48 as close to the shelf ledge 24 as possible in all four corners of the incubator 10. After the shelf 14 is inserted, leveling measure devices (not shown) may be placed left to right and front to back. The shelf leveling mechanisms would be adjusted one at a time until the shelf 14 is acceptably level per the application.

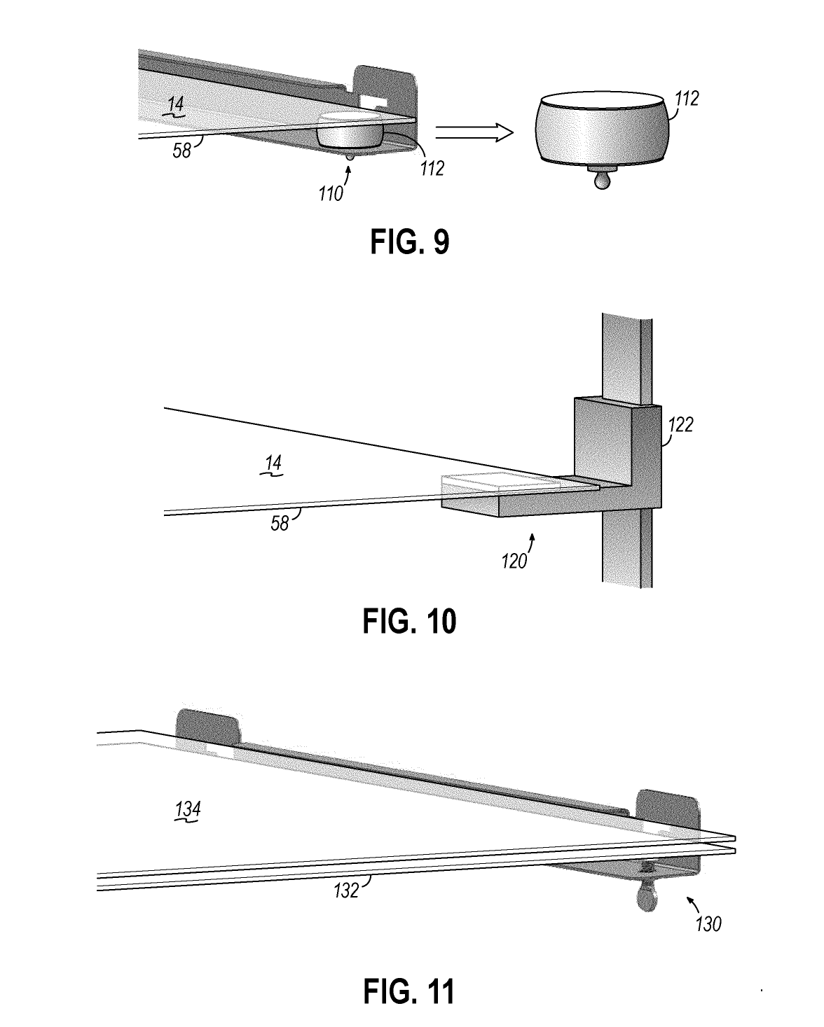

With reference to FIG. 4, the shelf support 18 is shown in use. The shelf support 18 is secured to the incubator wall 30. More specifically, the incubator wall 30 includes tabs 56 that are configured to engage the duct tabs 32 of the shelf support 18. To secure the shelf support 18 to the wall 30, a user may position the shelf support 18 such that the tabs 56 extend into the duct tabs 32. Once a shelf support 18 is secured on the wall 30 and an opposing wall (not shown), the user may position the shelf 14 on the shelf supports 18. An underside 58 of the shelf 14 rests on the support platforms 48. In this configuration, the heights of the four corners of the shelf 14 are individually adjustable to provide fine-tuning of the leveling of each shelf 14. To that end, the user may rotate one or more of the thumb screws 42. As the thumb screw 42 rotates, the engagement of threads 46 with the bore 50 provides an axially directed sliding motion of the thumb screw 42 and, thus, the support platform 48 toward or away from the ledge 24. It should be recognized that the shelf leveling mechanisms may be configured in a variety of ways. For example, with reference to FIG. 5, a shelf leveling mechanism 60 includes a motorized screw 62 in place of the thumb screw 42.

Referring generally to FIGS. 6-11, shelf supports and shelf leveling mechanisms according to a number of embodiments are shown. With reference to FIG. 6, according to an illustrative embodiment, the shelf support 18 is shown including shelf leveling mechanisms 64, 66. The shelf leveling mechanisms 64, 66 each include a screw 68. The screws 68 are rotatably secured to the shelf 14 and are rotatably engaged with the bores 50 of the ledge 24. As the screws 68 rotate, the shelf 14 is raised or lowered relative to the ledge 24.

With reference to FIG. 7, according to an illustrative embodiment, the shelf support 18 is shown including shelf leveling mechanisms 70, 72, each of which includes an eccentric cam 74. Each of the eccentric cams 74 is rotatable to adjust the height of a shelf.

With reference to FIG. 8, a shelf support 80 is shown constructed in accordance with an illustrative embodiment. The shelf support 80 comprises an elongate body 82 including an upright wall 84 and a ledge 86. The upright wall 84 includes two apertures 88, 90 for securing the shelf support 80 to an incubator wall 92. The incubator wall 92 includes a series of slanted slots 94. The shelf support 80 includes shelf leveling mechanisms 96, 98 configured to secure the shelf support 80 to the wall 92 and to adjust the height of a shelf (not shown). More particularly, the shelf leveling mechanisms 96, 98 each include a pin 100 and a fastener 102. The pins 100 are insertable through the apertures 88, 90 of the shelf support 80 and the slanted slots 94 of the wall 92. The fasteners 102 are used to secure the pins 100 to a particular position in the slanted slots 94. In this manner, a shelf may be leveled by adjusting the position of the pins 100 in the slanted slots 94.

With reference to FIG. 9, according to an embodiment, a shelf leveling mechanism 110 includes an inflatable bladder 112. Pumped air may be used to adjust the size of the bladder 112 and, thus, to adjust the height of a shelf.

With reference to FIG. 10, according to an embodiment, a shelf leveling mechanism 120 includes a linear actuator 122.

With reference to FIG. 11, according to an embodiment, a shelf support 130 includes a fixed shelf 132 configured to support the sample holder 134. The sample holder 134 may be, for example, a tray holding samples to be incubated.

While specific embodiments have been described in considerable detail to illustrate the present invention, the description is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. A shelf support for leveling a shelf of a laboratory climatic cabinet, the shelf support comprising:
a shelf support body configured to be secured to a wall of the laboratory climatic cabinet and to support the shelf; and
at least one shelf leveling mechanism associated with the shelf support body,
wherein, when the shelf is supported by the shelf support, the at least one shelf leveling mechanism is configured to adjust a distance between the shelf and a floor of the laboratory climatic cabinet.

2. The shelf support of claim 1, wherein the shelf support body is elongate and includes an upright wall and a ledge, the upright wall being configured to engage the wall of the laboratory climatic cabinet, and the ledge being configured to operatively support the shelf.

3. The shelf support of claim 2, wherein, when the shelf is positioned on the shelf support, the at least one shelf leveling mechanism is configured to adjust a height of the shelf relative to the ledge.

4. The shelf support of claim 2, wherein the ledge includes a first end and a second end, and further wherein a first shelf leveling mechanism is located adjacent the first end, and a second shelf leveling mechanism is located adjacent the second end.

5. The shelf support of claim 2, wherein the upright wall includes at least one duct tab configured to cooperate with a corresponding feature on the wall of the laboratory climatic cabinet.

6. The shelf support of claim 1, wherein the shelf leveling mechanism includes a thumb screw and a support platform, the thumb screw being rotatably engaged with the elongate body.

7. The shelf support of claim 6, wherein the shelf support body includes a bore, the thumb screw extends through the bore, and rotation of the thumb screw adjusts the distance between the support platform and a portion of the elongate body.

8. The shelf support of claim 6, wherein the support platform is configured to support an underside of the shelf.

9. The shelf support of claim 1, wherein the shelf leveling mechanism includes at least one of a motorized screw, a screw rotatably fixed to the shelf, an eccentric cam, an inflatable bladder, and a linear actuator.

10. The shelf support of claim 1, wherein the shelf support body includes a bore, the shelf leveling mechanism includes a pin, and the pin is configured to extend through the bore and a slot in the wall of the laboratory climatic cabinet to secure the shelf support to the wall.

11. The shelf support of claim 10, wherein the slot in the wall of the laboratory climatic cabinet is slanted, and altering a position of the pin in the slot adjusts the distance between the shelf and the floor of the laboratory climatic cabinet.

12. The shelf support of claim 1, wherein the shelf support body has a first side and a second side, the first side is configured to be secured to a first wall of the laboratory climatic cabinet, and the second side is configured to be secured to a second wall of the laboratory climatic cabinet.

13. The shelf support of claim 12, wherein the shelf leveling mechanism is configured to adjust the distance between the shelf support and the floor of the laboratory climatic cabinet.

14. A laboratory climatic cabinet comprising:
a first wall;
a first shelf support, the first shelf support being secured to the first wall, the first shelf support comprising:
a first shelf support body configured to support a shelf; and
a first shelf leveling mechanism,
wherein, when the shelf is supported by the first shelf support, the first shelf leveling mechanism is configured to adjust a distance between the shelf and a floor of the laboratory climatic cabinet.

15. The laboratory climatic cabinet of claim 14, further comprising:
the shelf being supported by the first shelf support.

16. The laboratory climatic cabinet of claim 14, the first shelf support further comprising a second shelf leveling mechanism, wherein, when the shelf is positioned on the first shelf support, the second shelf leveling mechanism is configured to adjust the distance between the shelf and the floor of the laboratory climatic cabinet

17. The laboratory climatic cabinet of claim 14, further comprising:
a second wall; and
a second shelf support, the second shelf support being secured to the second wall, the second shelf support comprising:
a second shelf support body configured to be secured to a wall of the laboratory climatic cabinet and to support the shelf; and
a third shelf leveling mechanism,
wherein, when the shelf is positioned on the first and second shelf supports, the third shelf leveling mechanism is configured to adjust the distance between the shelf and the floor of the laboratory climatic cabinet.
